(19) United States
(12) Patent Application Publication
(10) Pub. No.: US 2011/0240582 A1
(43) Pub. Date: Oct. 6, 2011

(54) Fall-Back Support

(75) Inventor: Holger Streitz, Ludesch (AT)

(73) Assignee: LIEBHERR-WERK NENZING GMBH, Nenzing (AT)

(21) Appl. No.: 13/075,941

(22) Filed: Mar. 30, 2011

(30) Foreign Application Priority Data
Mar. 30, 2010 (DE) 10 2010 013 328.0

(51) Int. Cl. B66C 23/92

(52) U.S. Cl. 212/293

(57) ABSTRACT

The present disclosure relates to a fall-back support for a luffing boom which is attached to a boom head of a crane, having at least one pressure rod which is arranged between the luffing boom and the boom head and which bounds a fall-back movement of the luffing boom, wherein the at least one pressure rod includes a fiber composite tube, in particular an aluminum tube having a reinforcement of carbon fibers.

### CROSS REFERENCE TO RELATED APPLICATION

This application claims priority to German Patent Application No. 10 2010 013 328.0, entitled “Fall-Back Support”, filed Mar. 30, 2010, which is hereby incorporated by reference in its entirety for all purposes.

### TECHNICAL FIELD

The present disclosure relates to a fall-back support for a luffing boom which is attached to a boom head of a crane, having at least one pressure rod which is arranged between the luffing boom and the boom head and which bounds a fall-back movement of the luffing boom.

### BACKGROUND AND SUMMARY

Different solutions are known for the retention function of movable or fixed luffing booms. On the one hand, in this respect, pull ropes having a pressure support are used which are arranged on the front side of the luffing boom and which bound the fall-back movement of the luffing boom, for instance on a tearing of the load rope, for example. Such an arrangement of pull rope and pressure support is also called a bird swing colloquially. This solution, however, has the disadvantage that the crane has to be positioned with a certain spacing from adjacent building edges since the bird swing requires space to the front.

Furthermore, fall-back supports are known which have at least one pressure rod which is arranged between the luffing boom and the boom head and which thus bounds a fall-back movement of the luffing boom to the rear. In this respect, pressure rods are manufactured from a steel tube for such fall-back supports, which results in a high weight of the construction and a correspondingly reduced payload of the crane. In addition, only a relatively shorter boom can be erected due to the mass.

It is therefore the object of the present disclosure to provide a fall-back support by which higher payloads can be achieved, in particular by reducing the weight of the pressure rod.

This object is achieved in accordance with the present disclosure by a fall-back support wherein the at least one pressure rod includes a fiber composite tube, in particular an aluminum tube having a reinforcement of carbon fibers. In this respect it is a case of a fall-back support for a luffing boom which is attached to a boom head of a crane, having at least one pressure rod which is arranged between the luffing boom and the boom head and which bounds a fall-back movement of the luffing boom. In accordance with the present disclosure, the pressure rod in this respect includes a fiber composite tube. The use of such a fiber composite tube as a pressure rod allows a substantial weight reduction with an equal pressure resistance of the fall-back support. The payload of the boom can hereby be correspondingly increased or a correspondingly larger and longer boom can be used.

The pressure rod advantageously includes an aluminum tube having a reinforcement of carbon fibers. The use of such an aluminum-carbon fiber composite as a pressure rod results in a very strong and nevertheless light pressure rod. In addition, the use of an aluminum tube allows an easy connection of the pressure rod to the remaining construction, e.g. via end pieces, which can be connected without problem to the aluminum tube. The connection to the further construction, which is frequently problematic with fiber-reinforced plastic tubes, is therefore substantially simplified.

The pressure rod advantageously has a plurality of carbon fiber lamellae extending in the longitudinal direction of the pressure rod. The aluminum tube can be reinforced against buckling by the carbon fiber lamellae so that the pressure resistance is substantially increased. The fiber direction of the carbon fibers in the carbon fiber lamellae advantageously likewise extends in the longitudinal direction of the pressure rod.

Provision is advantageously made that the carbon fiber lamellae surround the aluminum tube in the peripheral direction (e.g., around a periphery of the rod) with intervals disposed therebetween. Weight can hereby again be saved since no continuous carbon fiber reinforcement is used which extends in the longitudinal direction of the aluminum tube, but rather the carbon fiber lamellae each have a certain interval between one another.

In this respect, a plurality of carbon fiber lamellae are advantageously used which each surround the aluminum tube in the peripheral direction with an equal interval from one another.

The use of carbon fiber lamellae also facilitates the manufacture of the pressure rod in accordance with the present disclosure since they can be manufactured separately and then connected to the aluminum rod.

The carbon fiber lamellae are advantageously arranged in a middle region of the pressure rod and do not extend into the end regions of the pressure rod. Weight can again also hereby be saved, while the middle region of the pressure rod particularly prone to kinking is reinforced by the carbon fiber lamellae. The length of the middle region with the carbon fiber lamellae in this respect advantageously amounts to between 10% and 90% of the total length of the pressure rod, further advantageously between 20% and 80%, further advantageously between 25% and 70% and further advantageously between 30% and 50% of the total length.

The carbon fiber lamellae further advantageously have a thickness in the radial direction which amounts to between 50% and 300% of the wall thickness of the aluminum tube, advantageously between 80% and 250%, further advantageously between 100% and 200%.

Further advantageously, more than three carbon fiber lamellae are provided, further advantageously more than five carbon fiber lamellae. Further advantageously, the number of carbon fiber lamellae amounts to between three and twenty, further advantageously between five and twelve.

Further advantageously, the pressure rod can have a winding of carbon fibers at least in a part region in the peripheral direction. Such a winding of carbon fibers allows a particularly effective damping of the pressure rod.

The winding of carbon fibers in this respect advantageously extends beyond the region of the carbon fiber lamellae. The winding of carbon fibers in this respect advantageously extends over more than 50% of the total length of the aluminum tube, further advantageously over more than 70%, further advantageously over more than 85%.

The thickness of the winding of carbon fibers in the radial direction advantageously amounts to less than 70% of the wall thickness of the aluminum tube and/or of the thickness of the carbon fiber lamellae, further advantageously less than 50%, further advantageously less than 30%. The thickness of the winding in this respect advantageously amounts to more than 5% of the wall thickness of the aluminum tube, further advantageously more than 10%.

Advantageously, no carbon fiber winding is provided in the end regions of the aluminum tube.

Provision is further advantageously made that the carbon fiber lamellae are arranged on the winding of carbon fibers. The pressure rod thus has the following structure from the inside to the outside, each layer contiguous with the adjoining layer: an aluminum tube, a layer formed by the winding of carbon fibers in the peripheral direction and the carbon fiber lamellae arranged on this winding.

The use in accordance with the present disclosure of an aluminum carbon fiber composite tube allows a particularly simple connection of the pressure rod via end pieces which are connected to the aluminum tube.

The fall-back support in this respect advantageously has at least one first end piece which allows a bolting together of the fall-back support. This end piece in particular has at least one lug with bore for this purpose through which a bolt can be guided. Further advantageously, the fall-back support has a second end piece which engages in shape-matched manner in the case of strain into an end receiver at the luffing boom or at the boom head.

The pressure rod can effectively bound or prevent the fall-back movement of the luffing boom by these end pieces, e.g. for the case that the load rope tears.

Further advantageously, the pressure rod in accordance with the present disclosure has a compressive strength of more than 500 kN.

The pressure rod in accordance with the present disclosure cannot only be used as a fall-back support for the luffing boom of a crane, but can rather be used anywhere a high strength at low weight is required.

The present disclosure therefore furthermore includes a pressure rod of an aluminum tube with a reinforcement of carbon fibers. Such an aluminum tube with a reinforcement of carbon fibers can be used everywhere high forces have to be taken up at low weight.

The pressure rod is advantageously designed in this respect as was already presented above. The pressure rod in this respect in particular has a plurality of carbon fiber lamellae extending in the longitudinal direction of the pressure rod. The carbon fiber lamellae are in this respect advantageously designed as was represented above.

The pressure rod further advantageously has a winding of carbon fibers in the peripheral direction. This winding is advantageously in this respect designed as was already represented above.

The fall-back support further advantageously has two end pieces which re connected to the ends of the aluminum tube. These end pieces advantageously serve the connection to the further construction.

The present disclosure furthermore includes a lattice construction, in particular a boom, having a fall-back support and/or a pressure rod, as was described above. The present disclosure in this respect in particular includes a boom of a crane at which a luffing boom is arranged, wherein, in accordance with the present disclosure, a fall-back support in accordance with the present disclosure is arranged between the luffing boom and the boom head. The present disclosure, however, also includes lattice constructions very generally in which one or more pressure rods in accordance with the present disclosure are used.

The present disclosure furthermore includes a crane having a fall-back support and/or having a pressure rod and/or having a lattice construction as was described above.

The present disclosure will now be described in more detail with reference to an embodiment and to drawings.

### BRIEF DESCRIPTION OF THE FIGURES

FIG. 1 shows an embodiment of a fall-back support in accordance with the present disclosure in a side view.

FIG. 2 shows an embodiment of a pressure rod in accordance with the present disclosure such as is used in the embodiment of a fall-back support in accordance with the present disclosure.

FIG. 3 shows the pivotal connection of the pressure rod in accordance with the present disclosure to pivotal connection points of a crane as takes place with the fall-back support in accordance with the present disclosure.

FIG. 4 shows a perspective representation of an embodiment of a pressure rod in accordance with the present disclosure.

FIG. 5 shows a plurality of views of the embodiment of a pressure rod already shown in FIG. 4. FIGS. 1-5 are shown approximately to scale, although other proportions are possible.

### DETAILED DESCRIPTION

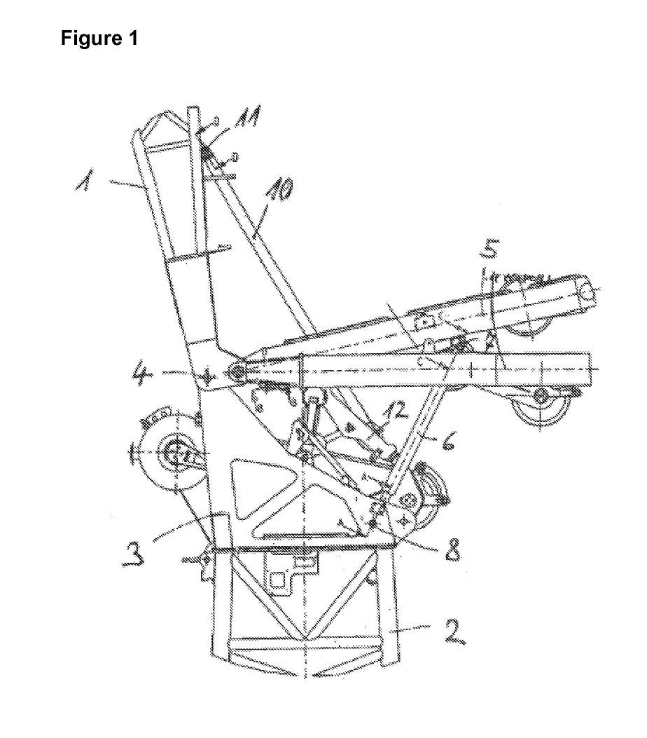

A fall-back support in accordance with the present disclosure is shown in FIG. 1. In this respect, the pivotal connection piece of a luffing boom 1 is shown which is arranged via a boom head 3 at the main boom 2 of a crane. Both the luffing boom 1 and the main boom 2 in this respect comprise a lattice construction. The luffing boom 1 and the main boom 2 are in particular composed of lattice pieces.

The luffing boom 1 is arranged pivotably about a horizontal axis 4 at the boom head 3. On a breakaway load or on violent wind gusts, the luffing boom can be urged from the front to the rear, whereby very high forces can arise in part. These forces have to be taken up by the fall-back support.

The fall-back support shown in FIG. 1 in this respect has two pressure rods 10 which are arranged between the pivotal connection piece of the luffing boom 1 and the boom head 3. The pressure rods 10 are in accordance with the present disclosure a fiber composite tube of an aluminum tube and a carbon fiber reinforcement which can take up the forces occurring on a load breakaway or on violent wind gusts despites its weight, which is substantially lower in comparison with a steel tube. The design of the pressure rods will in this respect be explained in more detail further below.

In addition to the two pressure rods 10 in accordance with the present disclosure, the fall-back support in FIG. 1 furthermore has two hydraulic cylinders 6 which are coupled via gas springs and which are arranged between the boom head 3 and the guying frame 5. The total backward rotating torque of the guying frames 5 is thus compensated via the gas springs 6. The backward rotating torque of the luffing boom is, in contrast, taken up by the pressure rods in accordance with the present disclosure which form rigid pressure rods.

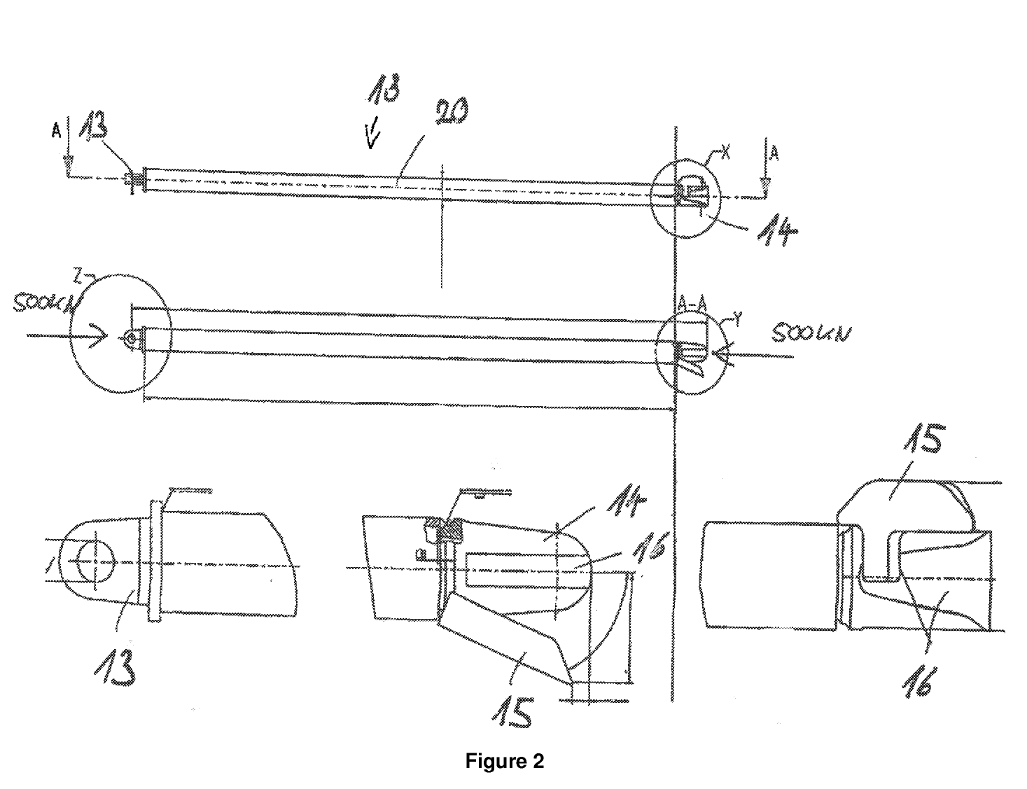

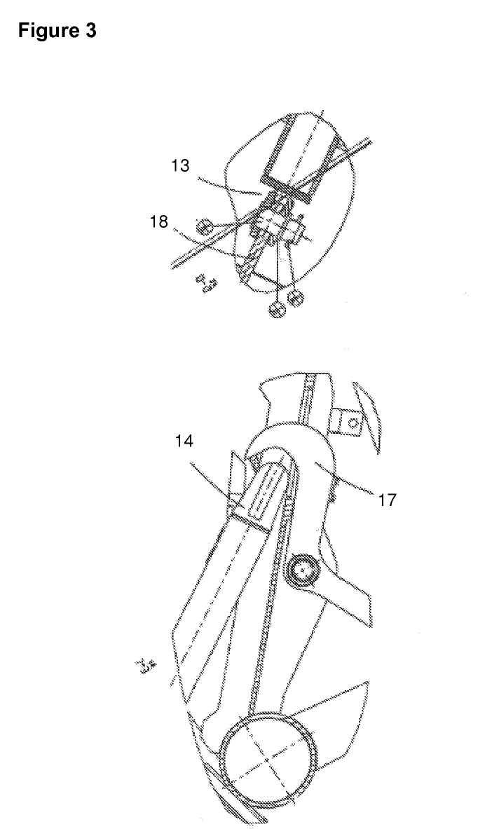

The pressure rods 10 used in accordance with the present disclosure in the fall-back support are shown in more detail in FIG. 2. The pressure rod 10 in this respect has an aluminum-carbon fiber composite tube 20 which will be described in more detail further below. This aluminum-carbon fiber composite tube 20 has end pieces 13 and 14 at the ends which serve the connection to the luffing boom or to the boom head. The end piece 13 in this respect has two lugs with a bore through which a bolt can be conducted. The end piece 14, in contrast, has an opening 16 at the end side as well as a guide element 15. The pivotal connection of the end pieces 13 and 14 is shown in FIG. 3 in this respect. The section E-E shows how the end piece 14 is secured by a hook-shaped receiver 17 which is pivotally arranged at the boom head. The end piece 13, in contrast, is bolted to the luffing boom via a fork-finger connection.

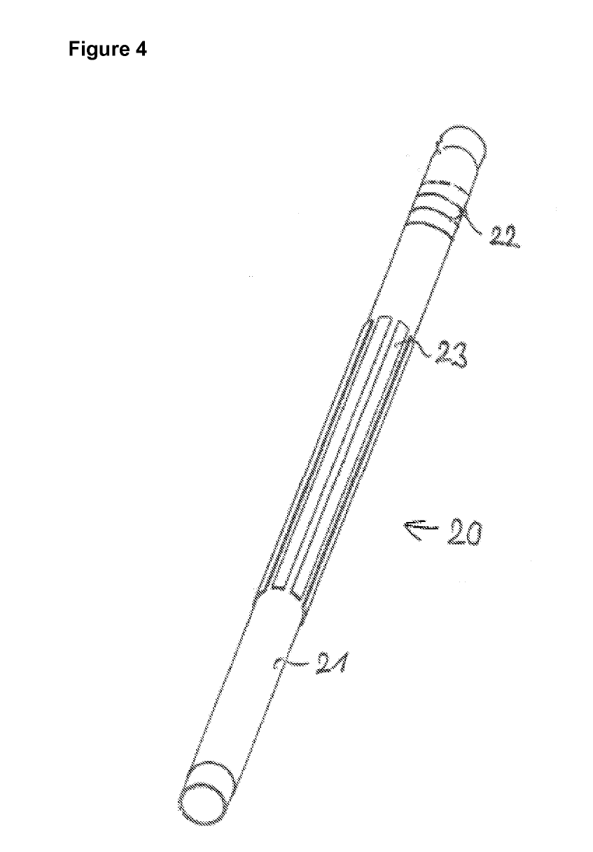

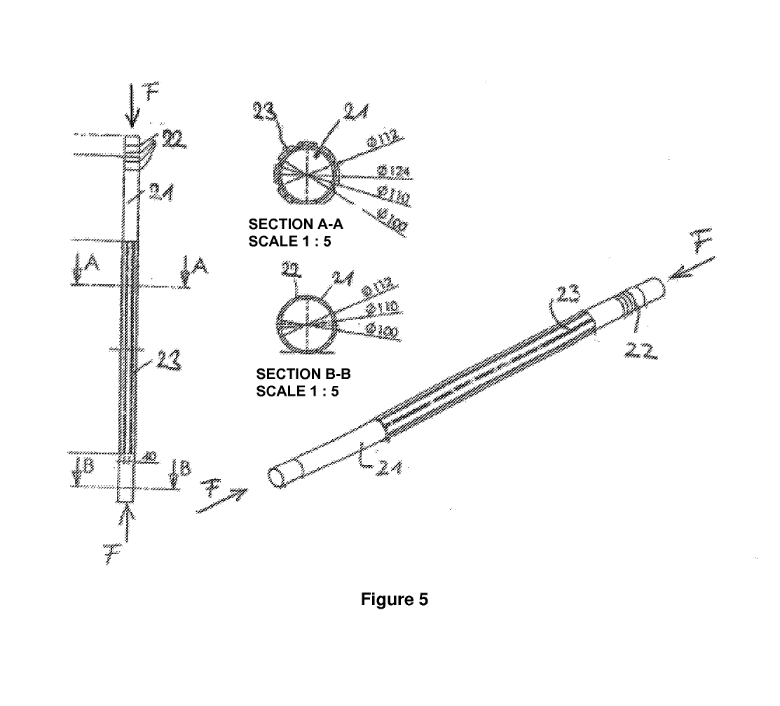

The fiber composite tube in accordance with the present disclosure is now shown in more detail in FIGS. 4 and 5. The fiber composite tube can, as shown above, be used as a fall-back support of a luffing boom. However, equally, application possibilities result everywhere high compressive forces have to be received with a light weight.

The pressure rod in accordance with the present disclosure in this respect includes an aluminum tube 21 which has a reinforcement of carbon fibers. In this respect, carbon fiber lamellae 23 are provided which extend in the longitudinal direction of the aluminum tube. The carbon fiber lamellae are in this respect arranged outwardly at the aluminum tube and surround it in the peripheral direction, with a certain spacing remaining between the individual carbon fiber lamellae. In this respect, respectively the same carbon fiber lamellae 23 are used which are arranged at regular intervals around the aluminum tube. In the embodiment, eight carbon fiber lamellae are used.

As can be seen from FIGS. 4 and 5, the carbon fiber lamellae 23 are arranged in a middle region of the aluminum tube and do not extend up to and into the end regions. In the embodiment, the carbon fiber lamellae in this respect have a length which corresponds to around 40% of the total length of the aluminum tube 21. The carbon fiber lamellae are in this respect arranged centrally with respect to the total length of the pressure rod so that in each case approximately equally long regions remain at the two ends of the pressure rod into which the carbon fiber lamellae do not extend.

The composite tube in accordance with the present disclosure furthermore has a winding 22 of carbon fibers. The carbon fibers are in this respect wound around the pressure rod and thus form an effective damping. The winding in this respect extends over a large part of the total length of the aluminum tube 21. A short piece is only not covered by the winding of carbon fibers at the two ends of the aluminum tube. The length of the non-wound end regions in this respect in the embodiment amounts to respectively less than 5% of the total length of the aluminum tube.

The carbon fiber lamellae 23 are in this respect applied to the winding 22 of carbon fibers. The fiber direction in the carbon fiber lamellae extends parallel to the longitudinal direction of the aluminum tube so that the kinking strength of the aluminum tube is substantially reinforced by the carbon fiber lamellae. The aluminum tube in contrast allows a particularly simple connection to end pieces via which the aluminum carbon fiber composite tube can be connected to the further structure.

In FIG. 5, the direction of the compressive force F is shown by the arrows which acts on the pressure rod in accordance with the present disclosure. The pressure rod in accordance with the present disclosure is in this respect designed in the embodiment so that it withstands a compressive force of more than 500 kN.

In the embodiment, the aluminum tube used has an inner diameter of 100 mm and an outer diameter of 110 mm. The aluminum tube thus has a wall thickness of 5 mm. The outer diameter of the composite tube in the region of the winding of carbon fibers in this respect amounts to 112 mm. The carbon fiber winding thus has a thickness of 1 mm. In the region of the carbon fiber lamellae, the tube in contrast has an outer diameter of 124 mm. The carbon fiber lamellae accordingly have a thickness of 6 mm. The total aluminum carbon fiber composite tube has a total length of approximately 2 m.

In this respect, it is obvious to the skilled person that the dimensional data given above only relate to a specific embodiment of the present disclosure which, however, enables a high compressive strength. The corresponding dimensions for the aluminum tube, the winding and the carbon fiber lamellae can, however, be adapted accordingly to other applications.

The present disclosure with the aluminum carbon fiber composite tube represents a particularly strong and nevertheless light pressure rod. It can in this respect in particular be used in a fall-back support in accordance with the present disclosure.

The present disclosure furthermore includes in addition to the pressure rod and the fall-back support, lattice constructions such as a boom in which they are used as well as a corresponding crane.

1. A fall-back support for a luffing boom which is attached to a boom head of a crane, having at least one pressure rod which is arranged between the luffing boom and the boom head and which bounds a fall-back movement of the luffing boom,
wherein the at least one pressure rod includes a fiber composite tube.

2. A fall-back support in accordance with claim 1, wherein the fiber composite tube comprises an aluminum tube having a reinforcement of carbon fibers, and wherein the pressure rod includes a plurality of carbon fiber lamellae extending in a longitudinal direction of the pressure rod.

3. A fall-back support in accordance with claim 2, wherein the carbon fiber lamellae surround the aluminum tube in the peripheral direction with intervals disposed therebetween.

4. A fall-back support in accordance with claim 2, wherein the carbon fiber lamellae are arranged in a middle region of the pressure rod and do not extend in the end regions of the pressure rod.

5. A fall-back support in accordance with claim 1, wherein the pressure rod has a winding of carbon fibers in a partial region in a peripheral direction.

6. A fall-back support in accordance with claim 5, wherein the winding of carbon fibers extends beyond the region of the carbon fiber lamellae; and/or wherein the carbon fiber lamellae are arranged on the winding of carbon fibers.

7. A fall-back support in accordance with claim 1 having at least one first end piece which allows a bolting of the fall-back support, and/or having a second end piece which engages in a shape-matched manner in the case of strain into an end receiver at the luffing boom or at the boom head.

8. A lattice construction, comprising:
a luffing boom;
a boom head; and
a fall-back support for the luffing boom which is attached to the boom head, the fall-back support having at least one pressure rod which is positioned between the luffing boom and the boom head and which bounds a fall-back movement of the luffing boom, wherein the at least one pressure rod includes a fiber composite.

9. A crane, comprising:
a luffing boom;
a boom head; and
a fall-back support for the luffing boom which is attached to the boom head, the fall-back support having at least one pressure rod which is positioned between the luffing boom and the boom head and which bounds a fall-back movement of the luffing boom, wherein the at least one pressure rod includes a fiber composite.

10. The crane in accordance with claim 9, wherein a middle region of the pressure rod experiencing a kinking force generated by the boom and head geometry is reinforced by carbon fiber lamellae spaced apart from one another around a periphery of the pressure rod, wherein each end region of the pressure rod is free of the carbon fiber lamellae.

11. The crane in accordance with claim 10, wherein the pressure rod further includes a carbon fiber winding extending over substantially the length of the rod, except that a short piece at each end only is not covered by the winding wherein the non-wound end regions amount to respectively less than 5% of the rod length.

12. The crane in accordance with claim 11, wherein the carbon fiber lamellae are positioned exterior to the winding of carbon fibers, and wherein a fiber direction in the carbon fiber lamellae extend parallel to a longitudinal direction of the rod.

13. The crane in accordance with claim 10, wherein the luffing boom is arranged pivotably about a horizontal axis at the boom head, and wherein the at least one pressure rod is positioned to take up forces on a breakaway load or on violent wind gusts.
